(19) United States
(12) Patent Application Publication
(10) Pub. No.: US 2022/0106739 A1
(43) Pub. Date: Apr. 7, 2022

(54) METHOD FOR MANUFACTURING INJECTION MOLDING MATERIAL AND INJECTION MOLDING MATERIAL

(71) Applicant: SEIKO EPSON CORPORATION, Tokyo (JP)

(72) Inventors: Satomi YOSHIOKA, Shiojiri (JP); Akio ITO, Matsumoto (JP)

(21) Appl. No.: 17/492,727

(22) Filed: Oct. 4, 2021

(30) Foreign Application Priority Data
Oct. 5, 2020 (JP) 2020-168313

(51) Int. Cl. D21H 17/00; D21H 17/36; D21H 17/28; D21H 23/04; D21H 21/06

(52) U.S. Cl. CPC D21H 17/72; D21H 17/36; D21H 21/06; D21H 23/04; D21H 17/28

(57) ABSTRACT

A method for manufacturing an injection molding material includes: an imparting step of imparting a water-soluble high molecular weight material to a cellulose raw material; a defibrating step of defibrating the cellulose raw material to which the water-soluble high molecular weight material is imparted to form a defibrated material; and a mixing step of mixing the defibrated material with a starch in a gas atmosphere.

The present application is based on, and claims priority from JP Application Serial Number 2020-168313, filed Oct. 5, 2020, the disclosure of which is hereby incorporated by reference herein in its entirety.

### BACKGROUND

### 1. Technical Field

The present disclosure relates to a method for manufacturing an injection molding material and an injection molding material.

### 2. Related Art

As a method for manufacturing a molded product, such as paper, a paper plate, or a paper-based board, containing cellulose fibers, a so-called dry method in which water is not or hardly used has been expected. In general, when a paper product is formed, a large amount of water is used, and hence, for example, in order to reduce the amount of water to be used, various developments have been carried out.

For example, JP-A-2019-001938 has disclosed a method to obtain defibrated cellulose fibers by mechanically defibrating a cellulose raw material together with a silicone-based surfactant and a method to manufacture a resin composition by using the defibrated cellulose fibers described above.

JP-A-2019-001938 has disclosed that by the addition of the silicone-based surfactant, cutting of the cellulose fibers by a mechanical defibration is suppressed. However, when the method as described above is used, the silicone-based surfactant remains on the cellulose fibers thus defibrated. The silicone-based surfactant may degrade the bonding between the fibers in some cases, and even if the fiber lengths of the cellulose fibers thus defibrated are maintained long, a mechanical strength of a molded product obtained by using the above cellulose fibers cannot be always increased in some cases.

Accordingly, a cellulose raw material which can maintain long cellulose fiber lengths even after a dry defibrating step and a molding material using the cellulose thus obtained which can form a molded product having a preferable mechanical strength have been pursued.

### SUMMARY

According to an aspect of the present disclosure, there is provided a method for manufacturing an injection molding material, the method comprising: an imparting step of imparting a water-soluble high molecular weight material to a cellulose raw material; a defibrating step of defibrating the cellulose raw material to which the water-soluble high molecular weight material is imparted to form a defibrated material; and a mixing step of mixing the defibrated material with a starch in a gas atmosphere.

According to another aspect of the present disclosure, there is provided an injection molding material which comprises: a fiberized cellulose; a water-soluble high molecular weight material; and a starch, and which has a density of 0.001 to 1.3 g/cm³.

### BRIEF DESCRIPTION OF THE DRAWINGS

FIGURE is a schematic view of a manufacturing apparatus according to an embodiment.

### DESCRIPTION OF EXEMPLARY EMBODIMENTS

Hereinafter, embodiments of the present disclosure will be described. The following embodiments are each described as one example of the present disclosure. The present disclosure is not limited to the following embodiments and includes various modified embodiments to be performed without departing from the scope of the present disclosure. In addition, all components to be described below are not always required to be essential components.

### 1. METHOD FOR MANUFACTURING INJECTION MOLDING MATERIAL

A method for manufacturing an injection molding material according to this embodiment includes an imparting step of imparting a water-soluble high molecular weight material to a cellulose raw material; a defibrating step of defibrating the cellulose raw material to which the water-soluble high molecular weight material is imparted to form a defibrated material; and a mixing step of mixing the defibrated material with a starch in a gas atmosphere.

### 1.1. Imparting Step

The method for manufacturing an injection molding material according to this embodiment includes the imparting step of imparting a water-soluble high molecular weight material to a cellulose raw material. The imparting step is performed before the defibrating step, and hence, cellulose (hereinafter, referred to as “cellulose fibers” in some cases) is suppressed from being shortened in the defibrating step.

### 1.1.1. Cellulose Raw Material

The cellulose raw material is not particularly limited as long as containing cellulose fibers. As the cellulose raw material, for example, there may be used pulp (a sheet or a veil of a broadleaf tree, a coniferous tree, a kenaf, a bagasse, a kapok, or the like); paper (such as copy paper, printing paper, or cardboard), waste paper, tissue paper, kitchen paper, a cleaner, a filter, a liquid absorber, an acoustic absorber, a buffer material, a mat, a corrugate board, or the like. In addition, as the cellulose raw material, at least two of the materials mentioned above by way of example may be used in combination.

The cellulose fibers in the cellulose raw material may be entangled or bonded to each other. In addition, as the cellulose raw material, a molded product manufactured using an injection molding material of this embodiment may also be used. Furthermore, the cellulose raw material is more preferably derived from natural or biomass materials. In addition, as the cellulose raw material, a material processed by bleaching or the like may also be used.

Since being an abundant plant-derived natural material, the cellulose is able to more properly correspond to environmental problems, saving of underground resources, and the like, and in addition, an injection molding material formed from the cellulose and a molded product manufactured from the injection molding material are preferable in terms of stable supply, cost reduction, and the like. In addition, since having a particularly high theoretical strength among various types of fibers, the cellulose has also an advantage in terms of further improvement in strength of the molded product. Furthermore, the cellulose has a preferable biodegradable property.

### 1.1.2. Water-Soluble High Molecular Weight Material

Since the water-soluble high molecular weight material is imparted to the cellulose raw material, when the cellulose in the cellulose raw material is defibrated in the defibrating step, the fiber lengths are suppressed from being shortened. The water-soluble high molecular weight material is not particularly limited as long as being a high molecular weight material having a water solubility. Since the water-soluble high molecular weight material is able to divide hydrogen bonds between the cellulose fibers, even by the dry defibration, the cellulose can be defibrated while damage to be done on the fibers is reduced.

As an example of the water-soluble high molecular weight material, for example, there may be mentioned a synthetic high molecular weight material, such as a poly(vinyl alcohol) (PVA), a poly(vinyl pyrrolidone) (PVP), a poly(acrylic acid), an ethylene-acrylic acid copolymer, a poly(ethylene glycol) (PEG), or a poly(propylene glycol) (PPG); a modified cellulose, such as a carboxymethyl cellulose (CMC), a methyl cellulose (MC), or a hydroxyethyl cellulose (HEC); or a natural or natural-derived high molecular weight material or polysaccharide, such as a guar gum, a carrageenan, a sodium alginate, a cationized guar gum, a xanthan gum, a sodium chondroitin sulfate, a sodium hyaluronate, a glue, or a casein.

Among those mentioned above, since being able to further suppress the cellulose fibers from being shortened by the defibration and being easily commercially available, at least one selected from the group consisting of a poly(vinyl alcohol) (PVA), a poly(acrylic acid), an ethylene-acrylic acid copolymer, a poly(ethylene glycol), a poly(propylene glycol), a polysaccharide, a modified cellulose, a glue, and a casein is preferable. In addition, at least two types of water-soluble high molecular weight materials may be used in combination.

In addition, when a poly(vinyl alcohol) (PVA) is used as the water-soluble high molecular weight material, a degree of polymerization of the PVA is preferably 300 to 2,000, more preferably 400 to 1,500, and further preferably 500 to 1,200. Since a PVA having the degree of polymerization as described above is used, an effect of suppressing the cellulose fibers from being shortened can be further enhanced, the water solubility is further improved, and the viscosity of the aqueous solution can also be suppressed to be low.

Furthermore, when a poly(vinyl alcohol) (PVA) is used as the water-soluble high molecular weight material, a saponification degree of the PVA is preferably 75% to 99% and more preferably 80% to 95%. Since a PVA having the saponification degree as described above is used, the water solubility can be easily set in an appropriate range in which the water-soluble high molecular weight material is used in the imparting step.

### 1.1.3. Method of Imparting Step

Although a method for imparting the water-soluble high molecular weight material to the cellulose raw material is not particularly limited, for example, there may be mentioned a method in which after an aqueous solution of the water-soluble high molecular weight material is prepared, the cellulose raw material is immersed therein; a method in which the aqueous solution described above is sprayed or applied on the cellulose raw material; or a method in which after a powdered water-soluble high molecular weight material is mixed with the cellulose raw material, water is added thereto if needed.

An imparting amount of the water-soluble high molecular weight material to the cellulose raw material is preferably 0.01 percent by mass or more, more preferably 0.02 percent by mass or more, even more preferably 0.05 percent by mass or more, and further preferably 0.1 percent by mass or more with respect to the cellulose raw material. In addition, an upper limit of the imparting amount is not particularly limited and is preferably 100.0 percent by mass or less and more preferably 80.0 percent by mass or less.

When the imparting amount of the water-soluble high molecular weight material to the cellulose raw material is the above lower limit or more, the cutting of the cellulose fibers in the defibration can be suppressed. In addition, when the imparting amount is the above upper limit or less, for example, adhesion of the water-soluble high molecular weight material to a defibrating device is likely to be suppressed.

In the imparting step, if an aqueous solution is used when the water-soluble high molecular weight material is imparted to the cellulose raw material, a concentration of the aqueous solution described above is not particularly limited and may be appropriately determined in consideration of the imparting amount of the water-soluble high molecular weight material to the cellulose raw material, the viscosity of the aqueous solution, the handling easiness of the aqueous solution, and the like.

When moisture is imparted to the cellulose raw material in the imparting step, the moisture may be either dried or not before the defibrating step. When the defibrating step is performed in a non-moisture state, the moisture imparted in the imparting step is preferably dried.

### 1.2. Defibrating Step

The method for manufacturing an injection molding material of this embodiment includes the defibrating step. The defibrating step is performed by defibrating the cellulose raw material in a dry atmosphere. By the defibrating step, a defibrated material containing fiberized cellulose fibers is obtained. The defibration may be performed, for example, by a defibrating portion of a manufacturing apparatus which will be described later. The defibrating step may be performed, for example, with a small amount of water if needed.

In the defibrating step, the defibration is not performed using a large amount of water and is performed in a gas atmosphere, such as in air or nitrogen. That is, the defibrating step may be performed either in a perfect dry state without water or in a state in which water vapor or a small amount of liquid water is present.

Although water or water vapor may be intentionally added in the defibrating step, in the case described above, the addition described above is preferably performed so that in the following steps, energy and/or time necessary to remove the water as described above by heating or the like is not excessively increased.

Hence, the injection molding material manufactured by the manufacturing method of this embodiment includes fiberized cellulose fibers. The fiberized cellulose fibers are one component of a molded product manufactured using the injection molding material and not only contributes to retention of the shape of the molded product but also maintains and improves the characteristics, such as a strength, of the molded product.

In this specification, the “fiberized cellulose” indicates a cellulose in the form of fibers which is obtained by defibrating a cellulose raw material, such as pulp or paper, containing cellulose. The fiberized cellulose may indicate one cellulose fiber or an aggregate (such as a cotton state) of cellulose fibers. By the fiberization, the cellulose in the cellulose raw material is disentangled into fibers.

Although not particularly limited, an average length of the fiberized cellulose fibers is preferably 0.1 to 50.0 mm, more preferably 0.2 to 5.0 mm, further preferably 0.3 to 3.0 mm. The lengths of the fiberized cellulose fibers may have a variation (distribution).

Accordingly, the shape stability, the strength, and the like of the molded product manufactured using the injection molding material can be further improved.

Although not particularly limited, an average thickness of the fiberized cellulose fibers is preferably 0.005 to 0.5 mm and more preferably 0.010 to 0.05 mm. The thickness of the fiberized cellulose fibers may have a variation (distribution).

Accordingly, the shape stability, the strength, and the like of the molded product manufactured using the injection molding material can be further improved. In addition, the surface of the molded product manufactured using the injection molding material can be further suppressed from being formed to have irregularity.

An average aspect ratio of the fiberized cellulose fibers, that is, a ratio of the average length to the average thickness, is not particularly limited, and the aspect ratio described above is preferably 10 to 1,000 and more preferably 15 to 500.

Accordingly, the shape stability, the strength, and the like of the molded product manufactured using the injection molding material can be further improved. In addition, the surface of the molded product manufactured using the injection molding material can be further suppressed from being formed to have irregularity.

The average length, the average thickness, and the average aspect ratio of the fiberized cellulose fibers may be measured, for example, by a commercially available fiber tester.

The fiberized cellulose has hydroxy groups, and hydrogen bonds are likely to be formed between the fiberized cellulose and a starch which will be described later; hence, a bonding strength between the fiberized cellulose and the starch and a strength of the entire molded product manufactured using the injection molding material, such as a specific tensile strength of a sheet-shaped molded product, can be further improved.

Although a content of the fiberized cellulose in the injection molding material is not particularly limited, for example, the content described above is preferably 20.0 to 99.0 percent by mass, more preferably 25.0 to 98.0 percent by mass, and further preferably 28.0 to 97.0 percent by mass. The content of the fiberized cellulose in the injection molding material may be adjusted by a mixing amount in the mixing step which will be described below.

Accordingly, the shape stability, the strength, and the like of the molded product manufactured using the injection molding material can be further improved. In addition, the moldability in the manufacturing of the molded product can be further improved, and the productivity of the molded product can also be advantageously improved.

In this embodiment, since the defibrating step is performed in the state in which the cellulose fibers and the water-soluble high molecular weight material are simultaneously present, the fiberized cellulose obtained by the defibrating step is not likely to have a short fiber length as compared to that of the cellulose in the original cellulose raw material.

### 1.3. Mixing Step

The method for manufacturing an injection molding material of this embodiment includes the mixing step. In the mixing step, the defibrated material formed in the defibrating step and the starch are mixed together in a gas atmosphere.

### 1.3.1. Starch

The injection molding material of this embodiment contains a starch. The starch is one component of the molded product manufactured using the injection molding material and not only contributes to the retention of the shape of the molded product but also maintains and improves the characteristics, such as a strength, of the molded product. In the molded product manufactured using the injection molding material, the starch is a component functioning as a binding material to bind the fiberized cellulose fibers to each other.

The starch is a high molecular weight material which is obtained by polymerization of α-glucose molecules with glycosidic bonds interposed therebetween. The starch may have either a linear structure or a branched structure.

As the starch, starches derived from various types of plants may be used. As a raw material of the starch, for example, there may be mentioned grains, such as corn, wheat, or rice; beans, such as broad beans, mung beans, or red beans; tubers and roots, such as potatoes, sweet potatoes, or tapiocas; wild grass, such as dogtooth violet, bracken, or kudzu; or palms such as sago palm.

In addition, as the starch, a processed starch or a modified starch may also be used. As the processed starch, for example, there may be mentioned an acetylated distarch adipate, an acetylated starch, an oxidized starch, a starch sodium octenyl succinate, a hydroxypropyl starch, a hydroxypropyl distarch phosphate, a monostarch phosphate, a phosphated distarch phosphate, an urea phosphorylated esterified starch, a sodium starch glycolate, or a high-amylose cornstarch. In addition, as the modified starch, for example, there may be mentioned an α-modified starch, a dextrin, a lauryl polyglucose, a cationized starch, a thermoplastic starch, or a starch carbamate.

A content of the starch with respect to the total mass of the injection molding material is preferably 2.0 to 70.0 percent by mass, more preferably 3.0 to 65.0 percent by mass, and further preferably 10.0 to 30.0 percent by mass. In addition, the content of the starch can be measured by a component analysis, such as an NMR method and, if needed, can be measured using a pre-treatment method, such as enzymolysis. The content of the starch in the injection molding material may be adjusted by a mixing amount in the mixing step which will be described below.

### 1.3.2. Method of Mixing Step

In this specification, “mixing performed in a gas atmosphere” indicates a mixing to be performed by an air-flow function. A mixing treatment in the mixing step is a method (dry method) in which the cellulose and the starch are introduced in an air flow and are then diffused to each other therein, and the mixing treatment described above is a hydrodynamic mixing treatment.

In the mixing step, the mixing is not performed using a large amount of water as a medium and is performed in a gas atmosphere, such as in air or nitrogen. That is, the mixing step may be performed either in a perfect dry state without water or in a state in which water vapor or a small amount of liquid water is present.

Although water or water vapor may be intentionally added in the mixing step, in the case described above, the addition described above is preferably performed so that in the following steps, energy and/or time necessary to remove the water as described above by heating or the like is not excessively increased.

The mixing step may be performed using a known apparatus, such as an FM mixer, a Henschel mixer, or a super mixer. In addition, as the apparatus, an apparatus which performs stirring by a high-speed rotating blade may be used, and an apparatus, such as a V type mixer, using the rotation of a container may also be used. Furthermore, a batch type apparatus or a continuous type apparatus may also be used. As one example of the continuous type apparatus, a mixing portion of the manufacturing apparatus which will be described later may be preferably mentioned.

### 1.4. Other Steps

The method for manufacturing an injection molding material may also include, for example, the following steps.

### 1.4.1. Plasticizer Imparting Step

The method for manufacturing an injection molding material may also include a plasticizer imparting step. The plasticizer imparting step imparts a plasticizer to the defibrated material. In addition, the plasticizer has a function to plasticize a starch, and since the plasticizer is imparted, the fluidization of the injection molding material is promoted by heating, and the molding thereof is more likely to be performed.

The plasticizer imparting step is performed at least after the defibrating step. Although a method of the plasticizer imparting step is not particularly limited as is the above method of the imparting step, for example, there may be mentioned a method in which after an aqueous solution of the plasticizer is prepared, the defibrated material is immersed therein; a method in which the aqueous solution described above is sprayed or applied on the defibrated material; or a method in which after a powdered plasticizer is mixed with the defibrated material, water is added thereto if needed.

As the plasticizer, for example, there may be mentioned glycerin, urea, guanidine hydrochloride, dimethylsulfoxide, a salicylate salt, an alkaline salt (such as sodium hydroxide, potassium hydroxide, a thiocyanate salt, potassium iodide, ammonium nitrate, or calcium chloride), an acid (a hydrochloric acid or a sulfuric acid), a sugar (sorbitol, xylitol, mannitol, erythritol, or lactitol). A plurality of plasticizers may also be used in combination. An amount of the plasticizer to be imparted in the plasticizer imparting step with respect to the starch is 0.01 to 30.0 percent by mass.

### 1.4.2. Processing Step

After the mixing step, the processing step may be performed, for example, so as to easily handle the injection molding material. Although the injection molding material is obtained through the mixing step, by further performing the processing step, the injection molding material may be formed into sheets, coarsely pulverized pieces, or pellets. That is, by the processing step described above, an injection molding material in the form of sheets, coarsely pulverized pieces, or pellets can be obtained.

### 1.4.3. Forming Step

A forming step can be performed, for example, by a forming portion of the manufacturing apparatus which will be described later, and in this case, a sheet-shaped injection molding material may be obtained. Furthermore, if needed, the sheet-shaped injection molding material may be cut by a shredder or the like, and in this case, an injection molding material in the form of shreds may be obtained. In addition, the processing step may also be performed by using a known pelletizer, and in this case, an injection molding material in the form of pellets may be obtained.

### 1.5. Injection Molding Material

As described above, the injection molding material according to this embodiment includes the fiberized cellulose, the water-soluble high molecular weight material, and the starch. Although the shape of the injection molding material may be any one of cotton dusts, webs, sheets, pellets, and the like, the density thereof is 0.001 to 1.3 g/cm³, preferably 0.005 to 1.15 g/cm³, more preferably 0.01 to 1.05 g/cm³, further preferably 0.05 to 0.95 g/cm³.

When the density of the injection molding material is in the range described above, for example, the handling of the material can be easily performed in the injection molding. When the density thereof is more than 1.3 g/cm³ or more, in the following kneading and injection molding steps, the dispersion of the material may become insufficient (material being not sufficiently disentangled), the composition of the molded product becomes non-uniform, and damas and irregularities may be generated thereby. In addition, when the density of the material is less than 0.001 g/cm³ or less, since the cellulose fibers are excessively sparsely present, for example, webs are not likely to be formed, and transportation thereof in the following kneading and/or injection molding step may be difficult to perform in some cases. In addition, when the density of the material is less than 0.001 g/cm³ or less, the individual materials are also liable to fall down from the cellulose.

In addition, as described above, although the injection molding material includes, besides the fiberized cellulose, the water-soluble high molecular weight material and the starch, the starch may bond the fiberized cellulose fibers to each other or may simply adhere thereto.

In addition, besides the cellulose, the water-soluble high molecular weight material, and the starch, the injection molding material may also contain a cellulose-derived glue, such as a natural gum glue including an etherized tamarind gum, an etherized locust bean gum, an etherized guar gum, or an acacia gum arabic; a polysaccharide such as a glycogen; a seaweed; an animal protein such as a collagen; a sizing agent; fiberized cellulose-derived impurities; starch-derived impurities; a hemicellulose; a lignin; and/or a synthetic high molecular weight material, such as a rayon, a lyocell, a cupra, a vinylon, an acrylic resin, a nylon, an aramid, a polyester, a polyethylene, a polypropylene, a polyurethane, or a polyimide.

However, a content of components other than the fiberized cellulose, the water-soluble high molecular weight material, and the starch in the injection molding material is preferably 10 percent by mass or less, more preferably 5.0 percent by mass or less, and further preferably 2.0 percent by mass or less.

The injection molding material may either contain or not contain water. A moisture content obtained when the injection molding material is left for 2 hours in an environment at a temperature of 27° C. and a relative humidity of 98% is, for example, 10 to 55 percent by mass.

In addition, the moisture content may be measured as described below. For example, after 0.7 g of the injection molding material is sampled and then laminated to form a disc shape on cooking paper using a Raffine Stainless Steel Automatic Powder Sifter M manufactured by Pearl Metal Co., Ltd., the injection molding material together with the cooking paper is placed on a stainless steel-made Pishat Net Basket (manufactured by Shinetsu Works Co., Ltd.) and is left for 2 hours in an environment at a temperature of 27° C. and a relative humidity of 98% using a constant-temperature oven (constant temperature and humidity device “Platinous” (registered trademark) K series PL-3KPH, manufactured by Espec Corp.). Subsequently, the moisture content is measured, for example, using a heat-drying type moisture meter (MX-50, manufactured by A&B Company).

### 1.6. Injection Molding

The injection molding material of this embodiment is used for injection molding. The injection molding may be performed using a known injection molding machine. When the water-soluble high molecular weight material is melted, the injection molding material of this embodiment is able to have a suitable fluidity for the injection molding. In addition, in the injection molding, water may be added to the injection molding material, and by this addition, the starch may be softened or may be made to function as a glue. Accordingly, the hydrogen bonds between the cellulose and the starch are likely to be formed. In addition, the hydrogen bonds between the cellulose fibers are also likely to be formed.

When the injection molding is performed using the injection molding material, a moisture amount to be added to the injection molding material is, as the moisture content, approximately 70 percent by mass, preferably 60 percent by mass or less, and more preferably 50 percent by mass or less. In addition, a temperature in the injection molding is preferably 50° C. to 200° C.

### 1.7. Molded Product

A molded product obtained by the injection molding of the injection molding material is a product molded to have a predetermined shape by a predetermined molding die. Accordingly, the molded product as described above is excellent in mechanical strength and biodegradable property. In addition, this molded product is also excellent in recycle characteristics, and even this molded product is recycled, the fiber lengths of the cellulose fibers are not likely to be shortened, and hence, the decrease in mechanical strength can be suppressed.

The shape of the molded product is not particularly limited, and for example, any shape, such as a sheet shape, a block shape, a spherical shape, or a three-dimensional steric shape, may be formed.

The molded product may be formed partially from the injection molding material described above and may also have a portion which is not formed from the injection molding material. Application of the molded product is also not particularly limited.

### 2. MANUFACTURING APPARATUS OF INJECTION MOLDING MATERIAL

Next, a manufacturing apparatus preferably applied to the method for manufacturing an injection molding material will be described. FIGURE is a schematic side view showing a preferable example of the manufacturing apparatus.

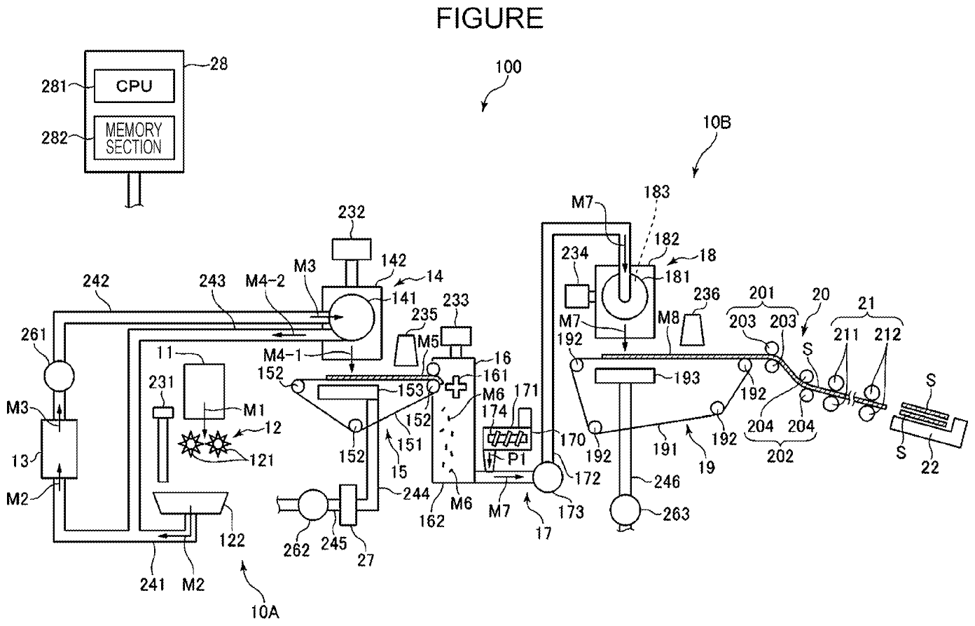

In addition, hereinafter, a top side in FIGURE is called “above” or “upper side”, and a bottom side in FIG. 1s called “below” or “lower side” in some cases. FIGURE is a schematic structural view, and a positional relationship between portions of a manufacturing apparatus 100 may be different from an actual positional relationship in some cases. In addition, in FIGURE, a direction in which a cellulose raw material M1, coarsely pulverized pieces M2, a defibrated material M3, a first sorted material M4-1, a second sorted material M4-2, a first web M5, fine segments M6, a mixture M7, a second web M8, and a sheet S are transported, that is, a direction indicated by an arrow, is also called a transport direction. In addition, a front end side and a base end side of the arrow are also called a transport-direction downstream and a transport-direction upstream, respectively.

The manufacturing apparatus 100 shown in FIGURE is an apparatus in which the cellulose raw material M1 is coarsely pulverized and defibrated, the water-soluble high molecular weight material and the starch are supplied as additives from an additive supply section 171, the fiberized cellulose, the water-soluble high molecular weight material, and the starch are mixed in a gas atmosphere by a mixing portion 17 and then deposited, and a sheet-shaped molded material is obtained by forming a deposit using a forming portion 20. Although the injection molding material is manufactured when the fine segments M6 pass through the mixing portion 17, according to the manufacturing apparatus 100, a sheet-shaped molded material is formed as the injection molding material.

In the following description, the case in which waste paper is used as the cellulose raw material M1 and in which a molded material to be manufactured is the sheet S which is recycled paper will be mainly described.

The manufacturing apparatus 100 shown in FIG. includes a sheet supply device 11, a coarsely pulverizing portion 12, a defibrating portion 13, a sorting portion 14, a first web forming portion 15, a segmenting portion 16, the mixing portion 17, a dispersing portion 18, a second web forming portion 19, the forming portion 20, a cutting portion 21, a stock portion 22, a recovery portion 27, and a control portion 28 which controls operations of those mentioned above. The coarsely pulverizing portion 12, the defibrating portion 13, the sorting portion 14, the first web forming portion 15, the segmenting portion 16, the mixing portion 17, the dispersing portion 18, the second web forming portion 19, the forming portion 20, the cutting portion 21, and the stock portion 22 are each a treatment portion to treat the sheet.

In addition, by the sheet supply device 11 and one of the coarsely pulverizing portion 12 and the defibrating portion 13, a sheet treating device 10A is formed. In addition, by the sheet treating device 10A and the second web forming portion 19, a fiber body depositing device 10B is formed.

In addition, the manufacturing apparatus 100 includes a humidifying portion 231, a humidifying portion 232, a humidifying portion 233, a humidifying portion 234, a humidifying portion 235, and a humidifying portion 236. In addition, the manufacturing apparatus 100 also includes a blower 261, a blower 262, and a blower 263.

In addition, since the control portion 28 is electrically coupled to the humidifying portions 231 to 236 and the blowers 261 to 263, the operations thereof are controlled by the control portion 28. That is, in this embodiment, by one control portion 28, the portions of the manufacturing apparatus 100 are configured to be controlled. However, the structure is not limited to that described above, and for example, a control portion to control the operations of the portions of the sheet supply device 11 and a control portion to control the operations of the portions other than those of the sheet supply device 11 may be separately provided.

In addition, in the manufacturing apparatus 100, a raw material supply step, a coarsely pulverizing step, a defibrating step, a sorting step, a first web forming step, a segmenting step, a mixing step, a discharging step, a depositing step, a sheet forming step, and a cutting step are conducted. Among those steps mentioned above, the mixing step corresponds to the mixing step in the method for manufacturing an injection molding material.

Hereinafter, the structure of each portion will be described. The sheet supply device 11 is a device to perform the raw material supply step of supplying the cellulose raw material M1 to the coarsely pulverizing portion 12. As the cellulose raw material M1, a material containing cellulose is used. In addition, as the cellulose raw material M1, a molded product of an injection molding material which contains a fiberized cellulose, a water-soluble high molecular weight material, and a starch, the latter two being adhered to the fiberized cellulose, may also be used.

The coarsely pulverizing portion 12 is a portion to perform the coarsely pulverizing step of coarsely pulverizing the cellulose raw material M1 supplied from the sheet supply device 11 in a gas atmosphere, such as in the air. The coarsely pulverizing portion 12 includes a pair of coarsely pulverizing blades 121 and a chute 122.

Since the pair of coarsely pulverizing blades 121 is rotated in opposite directions, the cellulose raw material M1 is coarsely pulverized therebetween, that is, the coarsely pulverized pieces M2 are obtained by cutting. The shape and the size of the coarsely pulverized piece M2 are preferably suitable for a defibrating treatment in the defibrating portion 13, and for example, small pieces having a one-side length of 100 mm or less is preferable, and small pieces having a one-side length of 10 mm to 70 mm is more preferable.

The chute 122 is disposed at a lower side of the pair of coarsely pulverizing blades 121 and is formed, for example, to have a funnel shape. Accordingly, the chute 122 is able to receive the coarsely pulverized pieces M2 which are coarsely pulverized by the coarsely pulverizing blades 121 and are then allowed to fall.

In addition, at an upper side of the chute 122, the humidifying portion 231 is disposed adjacent to the pair of coarsely pulverizing blades 121. The humidifying portion 231 is a portion to humidify the coarsely pulverized pieces M2 in the chute 122. This humidifying portion 231 is formed of a vaporizing humidifier in which a filter containing moisture is provided, and since air is allowed to pass through the filter, humidified air having a high humidity is supplied to the coarsely pulverized pieces M2. Since the humidified air is supplied to the coarsely pulverized pieces M2, the humidifying step described above can be performed, and the effect as described above can be obtained. In addition, the coarsely pulverized pieces M2 can be suppressed from being adhered to the chute 122 and the like caused by an electrostatic force.

The chute 122 is coupled to the defibrating portion 13 with a tube 241 interposed therebetween. The coarsely pulverized pieces M2 collected in the chute 122 are transported to the defibrating portion 13 after passing through the tube 241.

When the manufacturing apparatus 100 is used for the method for manufacturing an injection molding material of this embodiment, before the coarsely pulverized pieces M2 are introduced in the defibrating portion 13, the water-soluble high molecular weight material is imparted thereto. The water-soluble high molecular weight material may be imparted either to the cellulose raw material M1 or to the coarsely pulverized pieces M2. When the water-soluble high molecular weight material is imparted to the coarsely pulverized pieces M2, the coarsely pulverized pieces M2 correspond to the cellulose raw material. In addition, the water-soluble high molecular weight material may be imparted by an appropriate device not shown in the manufacturing apparatus 100 or may be imparted outside the apparatus before the cellulose raw material M1 is introduced in the manufacturing apparatus 100.

The defibrating portion 13 is a portion to perform the defibrating step of defibrating the coarsely pulverized pieces M2 in a gas atmosphere, that is, in a dry atmosphere. By the defibrating treatment in this defibrating portion 13, the defibrated material M3 can be formed from the coarsely pulverized pieces M2. In this case, “defibrate” indicates that the coarsely pulverized pieces M2 in which fiberized cellulose fibers are bound to each other are disentangled into independent fibers. In addition, the disentangled fibers as described above collectively form the defibrated material M3. The fibers of the defibrated material M3 each have a linear shape or a belt shape. In addition, the fibers of the defibrated material M3 may also be entangled with each other to form an aggregate, that is, may be present so as to form so-called “damas”.

In this embodiment, the defibrating portion 13 is formed, for example, of an impeller mill including a high-speed rotating blade and a liner located at an outer circumference of the rotating blade. The coarsely pulverized pieces M2 flowing into the defibrating portion 13 are defibrated after being sandwiched between the rotating blade and the liner.

In addition, by the rotation of the rotating blade, the defibrating portion 13 is able to generate a flow of air, that is, an air flow, from the coarsely pulverizing portion 12 to the sorting portion 14. Accordingly, the coarsely pulverized pieces M2 can be sucked to the defibrating portion 13 from the tube 241. In addition, after the defibrating treatment, the defibrated material M3 can be supplied to the sorting portion 14 through a tube 242.

At a certain point of the tube 242, the blower 261 is disposed. The blower 261 is an air flow generator to generate an air flow toward the sorting portion 14. Accordingly, the supply of the defibrated materials M3 to the sorting portion 14 is promoted.

The sorting portion 14 is a portion to perform the sorting step of sorting the defibrated material M3 by the lengths of the fiberized cellulose fibers. In the sorting portion 14, the defibrated material M3 is sorted into the first sorted material M4-1 and the second sorted material M4-2 larger than the first sorted material M4-1. The fibers of the first sorted material M4-1 each have a size suitable for a subsequent production of the sheet S. An average length of the fibers of the first sorted material M4-1 is preferably 1 to 30 μm. On the other hand, the second sorted material M4-2 includes, for example, insufficiently defibrated coarsely pulverized pieces and defibrated and fiberized cellulose fibers excessively aggregated together.

The sorting portion 14 includes a drum section 141 and a housing section 142 receiving the drum section 141.

The drum section 141 is formed of a cylindrical net member and is a sieve to be rotated around a central shaft thereof. Into this drum section 141, the defibrated material M3 flows. In addition, when the drum section 141 is rotated, fibers of the defibrated material M3 smaller than openings of the net are sorted as the first sorted material M4-1, and fibers of the defibrated material M3 larger than the openings of the net are sorted as the second sorted material M4-2. The first sorted material M4-1 falls from the drum section 141.

On the other hand, the second sorted material M4-2 is supplied to a tube 243 coupled to the drum section 141. One side of the tube 243 opposite to the drum section 141, that is, an upstream of the tube 243, is coupled to the tube 241. The second sorted material M4-2 passing through this tube 243 meets the coarsely pulverized pieces M2 in the tube 241 and then flows into the defibrating portion 13 together with the coarsely pulverized pieces M2. Accordingly, the second sorted material M4-2 is returned to the defibrating portion 13 and is again treated by the defibrating treatment together with the coarsely pulverized pieces M2.

In addition, while being dispersed in air, the first sorted material M4-1 falls from the drum section 141 toward the first web forming portion 15 located below the drum section 141. The first web forming portion 15 is a portion to perform the first web forming step of forming the first web M5 from the first sorted material M4-1. The first web forming portion 15 includes a mesh belt 151, three tension rollers 152, and a suction section 153.

The mesh belt 151 is an endless belt, and the first sorted material M4-1 is deposited thereon. This mesh belt 151 is stretched around the three tension rollers 152. In addition, by a rotational drive of the tension rollers 152, the first sorted material M4-1 on the mesh belt 151 is transported downstream.

The fibers of the first sorted material M4-1 have a size larger than openings of the mesh belt 151. Accordingly, the first sorted material M4-1 is not allowed to pass through the mesh belt 151 and, hence, can be deposited on the mesh belt 151. In addition, while being deposited on the mesh belt 151, the first sorted material M4-1 is transported downstream together with the mesh belt 151 and is then formed into a layered first web M5.

In addition, the first sorted material M4-1 may be unfavorably mixed, for example, with dust and the like in some cases. The dust and the like may be generated, for example, by the coarse pulverization and/or the defibration. In addition, the dust and the like as described above can be recovered by the recovery portion 27.

The suction section 153 is a suction mechanism to suck air from a lower side of the mesh belt 151. Accordingly, the dust and the like passing through the mesh belt 151 can be sucked together with air.

In addition, the suction section 153 is coupled to the recovery portion 27 through a tube 244. The dust and the like sucked in the suction section 153 is recovered by the recovery portion 27.

To the recovery portion 27, a tube 245 is further coupled. In addition, at a certain point of the tube 245, the blower 262 is disposed. By the operation of this blower 262, a suction force can be generated in the suction section 153. Accordingly, the formation of the first web M5 on the mesh belt 151 can be promoted. This first web M5 is a web from which the dust and the like are removed. In addition, by the operation of the blower 262, the dust and the like reaches the recovery portion 27 through the tube 244.

The housing section 142 is coupled to the humidifying portion 232. The humidifying portion 232 is formed of a vaporizing humidifier. Accordingly, in the housing section 142, humidified air is supplied. By this humidified air, the humidifying step described above can be performed, and the effect as described above can be obtained. In addition, the first sorted material M4-1 can be humidified, and as a result, the first sorted material M4-1 can also be suppressed from being adhered to an inner wall of the housing section 142 caused by an electrostatic force.

The humidifying portion 235 is disposed downstream of the sorting portion 14. The humidifying portion 235 is formed of an ultrasonic type humidifier which sprays water. Accordingly, moisture can be supplied to the first web M5, and hence, a moisture amount of the first web M5 is adjusted. By this adjustment, the humidifying step can be performed, and the effect as described above can be obtained. In addition, adsorption of the first web M5 to the mesh belt 151 caused by an electrostatic force can be suppressed. Accordingly, the first web M5 can be easily peeled away from the mesh belt 151 at a position at which the mesh belt 151 is folded by the tension roller 152.

The segmenting portion 16 is disposed downstream of the humidifying portion 235. The segmenting portion 16 is a portion to perform the segmenting step of segmenting the first web M5 peeled away from the mesh belt 151. The segmenting portion 16 includes a rotatably supported propeller 161 and a housing section 162 receiving the propeller 161. In addition, by the rotary propeller 161, the first web M5 can be segmented. The first web M5 thus segmented forms the fine segments M6. In addition, the fine segments M6 fall in the housing section 162.

The housing section 162 is coupled to the humidifying portion 233. The humidifying portion 233 is formed of a vaporizing humidifier. Accordingly, humidified air can be supplied in the housing section 162. By this humidified air, the humidifying step can be performed, and the effect as described above can be obtained. In addition, the fine segments M6 can be suppressed from being adhered to the propeller 161 and an inner wall of the housing section 162 caused by an electrostatic force.

The mixing portion 17 is disposed downstream of the segmenting portion 16. The mixing portion 17 is a portion to perform the mixing step of mixing the fine segments M6 and the additives. This mixing portion 17 includes the additive supply section 171, a tube 172, and a blower 173.

The tube 172 couples the housing section 162 of the segmenting portion 16 to a housing 182 of the dispersing portion 18 and functions as a flow path through which the mixture M7 of the fine segments M6 and the additives passes.

To a certain point of the tube 172, the additive supply section 171 is coupled. The additive supply section 171 includes a housing 170 receiving the additives and a screw feeder 174 provided in the housing 170. By the rotation of the screw feeder 174, the additives in the housing 170 are pushed out of the housing 170 and are supplied in the tube 172. The additives supplied in the tube 172 are mixed with the fine segments M6 to form the mixture M7.

In addition, as the additives to be supplied from the additive supply section 171, for example, there may be mentioned a binding agent which binds the fibers to each other, a colorant which colors the fibers, an aggregation suppressor which suppresses aggregation of the fibers, a flame retardant agent which enables the fibers and the like to hardly burn, a paper strength enhancer which increases a paper force of the sheet S, and/or the defibrated material, and those additives mentioned above may be used alone, or at least two types thereof may be used in combination. Hereinafter, the case in which a starch P1 is used as the additive will be described.

Since the starch P1 is supplied from the additive supply section 171, even when a content of the starch in the cellulose raw material M1 is relatively low, or even when a relatively large amount of the starch contained in the cellulose raw material M1 is removed during the treatment performed using the manufacturing apparatus 100, a preferable injection molding material can be obtained. That is, the contents of the water-soluble high molecular weight material and the starch in the injection molding material each can be set in a predetermined range.

In addition, at a certain point of the tube 172, the blower 173 is disposed downstream of the additive supply section 171. By an operation of a rotary portion, such as a blade, of the blower 173, mixing between the fine segments M6 and the starch P1 is promoted. In addition, the blower 173 is able to generate an air flow toward the dispersing portion 18. By this air flow, in the tube 172, the fine segments M6 and the starch P1 can be stirred with each other. The fine segments M6 in the mixture M7 are disentangled while passing through the tube 172 and are formed into finer fibers. Accordingly, in the mixture M7, the fine segments M6 are disentangled, and the starch P1 is uniformly dispersed. That is, by the treatment performed in the mixing portion 17, the injection molding material is formed so that in the aggregate of the fiberized cellulose, the starch is uniformly distributed.

In this embodiment, since the mixture M7 which is the injection molding material is formed into a sheet shape, the mixture M7 is further transported to the dispersing portion 18. In addition, the mixture M7, the second web M8, and the sheet S each correspond to the injection molding material.

In addition, the blower 173 is electrically coupled to the control portion 28, and the operation is controlled thereby. In addition, by adjusting an air volume supplied by the blower 173, an amount of air to be supplied in a drum 181 can be adjusted.

In addition, although not shown in the drawing, the tube 172 is branched into two ways at a drum 181-side end portion, and the branched end portions are coupled to inlet ports (not shown) formed at end surfaces of the drum 181.

The dispersing portion 18 shown in FIGURE is a portion to perform the discharging step in which entangled fibers of the mixture M7 are disentangled and discharged. The dispersing portion 18 includes the drum 181 to introduce and discharge the mixture M7, the housing 182 to receive the drum 181, and a drive power source 183 to rotationally drive the drum 181.

The drum 181 is formed of a cylindrical net member and is a sieve to be rotated around a central shaft thereof. When the drum 181 is rotated, the fibers and the like of the mixture M7 smaller than openings of the net are allowed to pass through the drum 181. In this step, the mixture M7 is further disentangled and then discharged together with air. That is, the drum 181 functions as a discharge section to discharge the material including the fibers.

Although not shown in the drawing, the drive power source 183 includes a motor, a decelerator, and a belt. The motor is electrically coupled to the control portion 28 with a motor driver interposed therebetween. In addition, a rotational force output from the motor is decelerated by the decelerator. The belt is formed, for example, of an endless belt and is stretched around an output shaft of the decelerator and an outermost circumference of the drum. Accordingly, a rotational force of the output shaft of the decelerator is transmitted to the drum 181 with the belt interposed therebetween.

In addition, the housing 182 is coupled to the humidifying portion 234. The humidifying portion 234 is formed of a vaporizing humidifier. Accordingly, humidified air is supplied in the housing 182. By this humidified air, the inside of the housing 182 can be humidified, the humidifying step can be performed, and the effect as described above can be obtained. In addition, the mixture M7 can also be suppressed from being adhered to an inner wall of the housing 182 caused by an electrostatic force.

In addition, while being dispersed in air, the mixture M7 discharged from the drum 181 falls toward the second web forming portion 19 located below the drum 181. The second web forming portion 19 is a portion to perform the depositing step of forming the second web M8 which is a deposit formed by the deposition of the mixture M7. The second web forming portion 19 includes a mesh belt 191, four tension rollers 192, and a suction section 193.

The mesh belt 191 is a mesh member and, according to the structure shown in the drawing, is formed of an endless belt. In addition, on the mesh belt 191, the mixture M7 which is dispersed and discharged by the dispersing portion 18 is deposited. This mesh belt 191 is stretched around the four tension rollers 192. In addition, by a rotational drive of the tension rollers 192, the mixture M7 on the mesh belt 191 is transported downstream.

In addition, in the structure shown in the drawing, although the mesh belt 191 is used as one example of the mesh member, the present disclosure is not limited thereto, and for example, a belt having a flat plate shape may also be used.

In addition, sizes of almost all the fibers and the like of the mixture M7 on the mesh belt 191 are equal to or larger than openings of the mesh belt 191. Accordingly, the mixture M7 is restricted to pass through the mesh belt 191 and hence, can be deposited on the mesh belt 191. In addition, while being deposited on the mesh belt 191, since the mixture M7 is transported downstream together with the mesh belt 191, a layered second web M8 is formed from the mixture M7.

The suction section 193 is a suction mechanism to suck air from a lower side of the mesh belt 191. Accordingly, the mixture M7 can be sucked on the mesh belt 191, and hence the deposition of the mixture M7 on the mesh belt 191 can be promoted.

A tube 246 is coupled to the suction section 193. In addition, at a certain point of this tube 246, the blower 263 is disposed. By the operation of this blower 263, a suction force can be generated in the suction section 193.

The humidifying portion 236 is disposed downstream of the dispersing portion 18. The humidifying portion 236 is formed of an ultrasonic type humidifier similar to that of the humidifying portion 235. Accordingly, moisture can be supplied to the second web M8, and hence, a moisture amount of the second web M8 can be adjusted. By this adjustment, the humidifying step can be performed, and the effect as described above can be obtained. In addition, adsorption of the second web M8 to the mesh belt 191 caused by an electrostatic force can be suppressed. Hence, the second web M8 can be easily peeled away from the mesh belt 191 at a position at which the mesh belt 191 is folded by the tension roller 192.

In addition, although a total moisture amount to be applied by the humidifying portion 231 to the humidifying portion 236 is not particularly limited, a moisture content of the mixture when the humidifying steps are completed, that is, a rate of the mass of moisture contained in the second web M8 with respect to the mass of the second web M8 humidified by the humidifying portion 236, is preferably 15 to 50 percent by mass, more preferably 18 to 45 percent by mass, and further preferably 20 to 40 percent by mass. In addition, if needed, the humidifying portion 234 and the humidifying portion 236 are operated so as to enable the second web M8 and the sheet S each used as the injection molding material to have shapes suitable for the injection molding.

The forming portion 20 is disposed downstream of the second web forming portion 19. The forming portion 20 is a portion to perform the sheet forming step of forming the sheet S from the second web M8 which is the mixture. This forming portion 20 includes a pressurizing section 201 and a heating section 202.

The pressurizing section 201 includes a pair of calendar rollers 203, and between the calendar rollers 203, the second web M8 can be pressurized without heating. Accordingly, the density of the second web M8 can be increased. This second web M8 is transported to the heating section 202. In addition, one of the pair of calendar rollers 203 is a drive roller to be driven by an operation of a motor not shown, and the other is a driven roller.

The heating section 202 includes a pair of heating rollers 204, and while being heated between the heating rollers 204, the second web M8 can be pressurized. Accordingly, the sheet S is formed. This sheet S is transported to the cutting portion 21. In addition, one of the pair of heating rollers 204 is a drive roller to be driven by an operation of a motor not shown, and the other is a driven roller.

The cutting portion 21 is disposed downstream of the forming portion 20. The cutting portion 21 is a portion to perform the cutting step of cutting the sheet S. This cutting portion 21 includes first cutters 211 and second cutters 212.

The first cutters 211 cut the sheet S in a direction intersecting the transport direction of the sheet S and, in particular, in a direction orthogonal thereto.

The second cutters 212 are cutters which cut the sheet S downstream of the first cutters 211 in a direction parallel to the transport direction of the sheet S. This cutting is performed so that the sheet S has a predetermined width by removing the two side ends thereof, that is, unnecessary ends in the width direction of the sheet S, and the ends thereof thus removed by the cutting are each called a so-called “end slice”.

By the cutting performed using the first cutters 211 and the second cutters 212, small sheets S each having a desired shape and size can be obtained. In addition, those small sheets S are further transported downstream and then stored in the stock portion 22.

In addition, the forming portion 20 is not limited to the structure in which the small sheets S are formed as described above, and for example, the structure in which, for example, block shapes or spherical shapes are formed as the molded material may also be used. In addition, the forming portion 20 may also include a shredder not shown, and the sheet S may be formed into shreds as the injection molding material.

The individual portions of the manufacturing apparatus 100 described above are each electrically coupled to the control portion 28. In addition, the operations of the portions described above are each controlled by the control portion 28.

The individual portions of the manufacturing apparatus to be used for the manufacturing of the injection molding material each may be replaced by an arbitrary component having a function similar to that described above. In addition, an arbitrary component may also be added to the manufacturing apparatus described above.

In addition, the method for manufacturing an injection molding material may include at least the steps up to the mixing step described above and may use, besides the manufacturing apparatus 100, any manufacturing apparatus.

### 3. EXAMPLE AND COMPARATIVE EXAMPLE

Hereinafter, although the present disclosure will be further described with reference to an example and a comparative example, the present disclosure is not limited to the following example.

### 3.1. Example 1

After a 0.5%-aqueous solution of a PVA (Denkapoval B-05, manufactured by Denka Company Ltd.) was sprayed to conifer pulp (NBKP: BRATSK, by Kokusai Pulp&Paper Co., Ltd.) in an amount of 0.07 percent by weight with respect to the pulp and was then dried, the pulp was coarsely pulverized by a shredder and was then introduced in a modified Paperlab A-8000 (manufactured by Seiko Epson Corporation) for defibration. The modified Paperlab A-8000 had the structure as shown in FIGURE and was configured so as to recover the defibrated material M3 between the defibrating portion 13 and the sorting portion 14.

### 3.2. Comparative Example 1

Except for that conifer pulp (NBKP: BRATSK) was used without being sprayed with the PVA aqueous solution, the defibration was performed in a manner similar to that in Example 1.

### 3.3. Measurement of Average Fiber Length

An average length and an average thickness of cellulose fibers of each of the defibrated materials obtained in Example 1 and Comparative Example 1 were measured using a Fiber Tester: 912 Plus, manufactured by L&W.

### 3.4. Measurement Results

The average length and the average thickness of the cellulose fibers of the defibrated material were as described below.

Example 1: average length: 1.5 mm, average thickness: 27.1 μm
Comparative Example 1: average length: 1.3 mm, average thickness: 26.3 μm

### 3.5. Conclusion

It was found that when the water-soluble high molecular weight material is imparted to the cellulose raw material, the average fiber length of the cellulose in the defibrated material can be maintained long. Accordingly, a molded product obtained by injection molding of an injection molding material manufactured using the defibrated material of Example 1 may be expected to have a preferable mechanical strength as compared to that obtained from the defibrated material of Comparative Example 1.

The present disclosure includes substantially the same structure as the structure described in the embodiment. That is, the substantially the same structure includes, for example, the structure in which the function, the method, and the result are the same as those described above, or the structure in which the object and the effect are the same as those described above. In addition, the present disclosure includes the structure in which a nonessential portion of the structure described in the embodiment is replaced with something else. In addition, the present disclosure includes the structure which performs the same operational effect as that of the structure described in the embodiment or the structure which is able to achieve the same object as that of the structure described in the embodiment. In addition, the present disclosure includes the structure in which a known technique is added to the structure described in the embodiment.

From the embodiments and the modified examples described above, the following contents are obtained.

A method for manufacturing an injection molding material, includes: an imparting step of imparting a water-soluble high molecular weight material to a cellulose raw material; a defibrating step of defibrating the cellulose raw material to which the water-soluble high molecular weight material is imparted to form a defibrated material; and a mixing step of mixing the defibrated material with a starch in a gas atmosphere to form a mixture.

According to this manufacturing method, since the cellulose raw material is defibrated together with the water-soluble high molecular weight material, the fiber length of the cellulose in the defibrated material is not likely to be shortened. In addition, since the defibrated material is mixed with the starch in a gas atmosphere, an injection molding material in which the starch is uniformly dispersed in a cellulose aggregate can be obtained. In addition, by addition of a small amount of water, the injection molding material thus obtained can be easily injection-molded, and a molded product having a preferable strength can be formed.

The manufacturing method described above may further include: a depositing step of depositing the mixture formed in the mixing step to form a web; and a forming step of heating and pressurizing the web to form a molded material.

According to this manufacturing method, an injection molding material which can be more easily handled as compared to a material in the form of cotton dusts and which can be more suitably applied to injection molding can be manufactured.

In the manufacturing method described above, the water-soluble high molecular weight material may be selected from the group consisting of a poly(vinyl alcohol), a poly(acrylic acid), an ethylene-acrylic acid copolymer, a poly(ethylene glycol), a poly(propylene glycol), a polysaccharide, a modified cellulose, a glue, and a casein.

According to this manufacturing method, in the defibration, since the fiber length of the cellulose can be maintained longer, an injection molding material which is more suitable for injection molding and which can form an injection-molded product having a more preferable strength can be manufactured.

In the manufacturing method described above, the starch may be selected from plant-derived starches.

According to this manufacturing method, a molded material having more preferable bonds between cellulose fibers can be formed, and an injection molding material also excellent in environmental compatibility can be manufactured.

In the manufacturing method described above, in the imparting step, the water-soluble high molecular weight material may be imparted in an amount of 0.01 percent by mass or more with respect to the cellulose raw material.

According to this manufacturing method, in the defibration, since the fiber length of the cellulose can be maintained longer, an injection molding material which is more suitable for injection molding and which can form an injection-molded product having a more preferable strength can be manufactured.

The manufacturing method described above may further include a plasticizer imparting step of imparting a plasticizer to the defibrated material.

According to this manufacturing method, in the injection molding, since the starch can be more easily fluidized, an injection molding material which can be more easily injection-molded can be manufactured.

An injection molding material includes: a fiberized cellulose; a water-soluble high molecular weight material; and a starch, and the injection molding material has a density of 0.001 to 1.3 g/cm³.

According to this injection molding material, the handling thereof can be more easily performed as compared to that of a material in the form of cotton dusts, the injection molding can be easily performed by addition of a small amount of water, and a molded product having a preferable strength can be formed.

What is claimed is:

1. A method for manufacturing an injection molding material, comprising:
an imparting step of imparting a water-soluble high molecular weight material to a cellulose raw material;
a defibrating step of defibrating the cellulose raw material to which the water-soluble high molecular weight material is imparted to form a defibrated material; and
a mixing step of mixing the defibrated material with a starch in a gas atmosphere to form a mixture.

2. The method for manufacturing an injection molding material according to claim 1, further comprising:
a depositing step of depositing the mixture formed in the mixing step to form a web; and
a forming step of heating and pressurizing the web to form a molded material.

3. The method for manufacturing an injection molding material according to claim 1,
wherein the water-soluble high molecular weight material is selected from the group consisting of a poly(vinyl alcohol), a poly(acrylic acid), an ethylene-acrylic acid copolymer, a poly(ethylene glycol), a poly(propylene glycol), a polysaccharide, a modified cellulose, a glue, and a casein.

4. The method for manufacturing an injection molding material according to claim 1,
wherein the starch is selected from plant-derived starches.

5. The method for manufacturing an injection molding material according to claim 1,
wherein in the imparting step, the water-soluble high molecular weight material is imparted in an amount of 0.01 percent by mass or more with respect to the cellulose raw material.

6. The method for manufacturing an injection molding material according to claim 1, further comprising:
a plasticizer imparting step of imparting a plasticizer to the defibrated material.

7. An injection molding material comprising:
a fiberized cellulose;
a water-soluble high molecular weight material; and
a starch,
wherein the injection molding material has a density of 0.001 to 1.3 g/cm³.
